(19) United States
(12) Patent Application Publication
(10) Pub. No.: US 2018/0196970 A1
(43) Pub. Date: Jul. 12, 2018

(54) VISUAL CHOICE SELECTION CONCEALMENT COMPUTING DEVICE AND METHOD OF OPERATION

(71) Applicants: Jose Miguel GOMES MOREIRA PEGO, Porto (PT); Nuno Miguel GONCALVES SANTOS, Matosinhos (PT)

(72) Inventors: Jose Miguel GOMES MOREIRA PEGO, Porto (PT); Nuno Miguel GONCALVES SANTOS, Matosinhos (PT)

(21) Appl. No.: 15/742,005

(22) PCT Filed: Jul. 4, 2016
(86) PCT No.: PCT/IB2016/054004

§ 371 Date: Jan. 4, 2018

(30) Foreign Application Priority Data
Jul. 7, 2015 (PT) 108669

(51) Int. Cl. G06F 21/84; G06F 3/0481

(52) U.S. Cl. CPC G06F 21/84; G09G 2358/00; G06F 3/0481

(57) ABSTRACT

The present application intends to solve the problem of concealing a choice selection from third-party vision using optical effects. Disclosed are methods designed so that the user making the selection can easily tell the difference between the two types of option, correct choice versus confounder, but that difference is blurred rapidly with distance—up to one meter distance becomes indistinguishable. The disclosed methods can be used to make individual choices (2) in environments of proximity with others while maintaining the confidentiality of choice, for example, questionnaires (1) in various fields of education, ATM, voting booths, etc.

### TECHNICAL FIELD

The present application relates to a visual choice selection concealment computing device and method of operation.

### BACKGROUND

Currently, choice selecting methods are based on physical or electronic media.

Physical systems commonly use paper support. The forms are presented in list format or matrix, identified with numbers, letters or symbols. The choice of the option is selected on the paper form with a graphic material (pen, pencil) signaling through identifying mark (circle, cross, etc.). Alternatively, the answer may be marked in a proper form for answers and prepared for automatic reading (for example, optical scanning).

The electronic media make use of computer programs that present the lists or forms and the decision maker chooses on a monitor through a man-machine interface (mouse, keyboard, touch screen, etc.). There are currently several formats in computerized selection (radio button, drop-down box, select box, etc.).

Some commercially/freeware available test administration platforms are described in the following. For e-learning:
Blackboard Microsoft Corporation (http://www.blackboard.com/)
Moodle—Open Source (http://moodle.org/)
Dokeos—Open Source (http://www.dokeos.com/)

And for online assessment:
http://www.questionmark.com
http://www.validateskills.com
http://www.lxrtest.net/site/software.aspx

### General Description

The present application intends to solve the problem of concealing a choice selection from third-party vision using optical effects.

Disclosed is a method of operating a computing device, based on obfuscation of the choice by visual effect of similarity between two forms of selection. The computing device comprises:
a screen display;
at least one input interface;
a data processing means; and
a memory.

In one embodiment, the input interface is any of: a button, a computer mouse, a touch screen, a camera or an infrared sensor.

Disclosed is also a method of operating a computing device, comprising the steps:
detecting a user selection event from an input interface;
display at least one unselected option image, comprising:
   a background square where all pixels have a brightness of at least 80%,
   a superimposed inner square where all pixels have a brightness of at most 85%;
display at least one selected option image, comprising:
   a background square where all pixels have a brightness of at least the unselected option image background square pixel brightness, and
   a superimposed inner shape comprising at least 1 pixel of the unselected option image inner square.

Upon presentation of the possible options, they all have the same unselected option image. When the user, the decision maker, chooses one of the options, the option image changes in order to signal the choice.

This change is important enough to be visible within a walking distance, but subtle enough to be indistinguishable at longer distances. The method is designed so that the user in proximity with the computing device, and selecting an option, can easily tell the difference between the unselected and the selected option images. Contrary, an observer at a greater distance from the computing device, cannot distinguish the difference between the two option images.

The concealment of the selected option allows the user to maintain the confidentiality of choice and protect the choice from the view of others. It is thus possible to make individual choices in environments of proximity with others while maintaining the confidentiality of choice.

In one embodiment, the inner shape is the superimposed inner square with empty rounded corners with at least one pixel radius.

In another embodiment, the empty rounded corner has a 3 pixel radius and a 1 pixel central vertex.

In a further embodiment, the inner shape comprises at least 1 pixel with at most the unselected option image inner square pixel brightness.

In one embodiment, the two outer pixel vertices of each corner have a brightness of 59%.

In another embodiment, the selected option image comprises a superimposed inner cross with a brightness of at most the inner shape pixel brightness, and an inner line with alternate pixel brightness between 100% and 90%.

In a further embodiment, the inner cross has an outer line with alternate pixel brightness between 64% and 41%.

In one embodiment, the inner cross has an outer line with alternate pixel brightness between 64% and 0%.

In a further embodiment, the selected option image comprises an edge with a width of at least 1 pixel and a brightness of at most the unselected option image background square pixel brightness.

In one embodiment, the brightness of a pixel is the normalized arithmetic mean of its Red-Green-Blue (RGB) coordinates.

In another embodiment, the brightness of a pixel is the value of its grayscale coordinate. The use of different shades of gray in the presentation of the option image, makes use of the short distance between the used spectral colors. This aspect enables a figure that, at a normal distance, effectively identifies the selected option but at a greater distance becomes imperceptible to human vision.

In current systems, due to the great contrast between the graphics option selected and all other, the choice is clearly identified for the decision maker and for anyone with visual access to the media or electronic where it makes the choice.

The present application presents, at least, the following advantageous effects:
minimizes the risk of loss of privacy—particularly important in conditions in which the confidentiality of the decision/choice/selection are relevant, for example, examinations, authentication terminal physical or electronic terminals;
applicable with both physical as well as electronic media;
easy to use and no need for complex programming and implementation;
enables automatic reading of the response;
exempts from hardware or facilities restructuring/upgrading.

The present application can be applied in all technical fields involving selection of a choice between two or more alternative mechanism by means of an interactive selection. The economic importance of the present application relates to the universality of use of the methods of choice in many aspects.

The usefulness of the present application reveals itself particularly in the use of computer platforms exams and distance learning systems which facilitate the use of fraud and plagiarism of information by third-parties.

Some institutions adopted strategies of concealment of physical monitors available to users through architectural resources, such as round tables with side barriers to separate users, and physical barriers. The present application allows to keep the provision of a classic exam room, with serial lines, while guaranteeing the confidentiality of information to one position by restricting the field of vision of the immediate observer. The present application is able to blind independently of other physical means (e.g. physical isolation panels, privacy filters monitor http://solutions.3 m.com/wps/portal/3M/en US/SDP/Privacy Filters/, etc.) and using existing resources.

Hence, the use of the present application in the context of tests, questionnaires and the like is important in various fields of education, sociology, psychology, medical sciences and others.

In other contexts, the use of authentication, e.g. pin code insertion in ATM and e-banking systems, and voting systems has economic benefits by avoiding the abuse of confidential information with the potential for fraud or financial advantage of knowledge.

### BRIEF DESCRIPTION OF DRAWINGS

Without intent to limit the disclosure herein, this application presents attached drawings of illustrated embodiments for an easier understanding.

FIG. 1 illustrates one embodiment of a transition between an unselected option image and a selected option image, where the reference numbers show:
100—a superimposed inner square;
101—distance to the leading edge;
102—a leading edge;
110—a superimposed inner shape;
111—background;
112—an empty rounded corner with a 4 pixel radius and a 1 pixel central vertex;
113—a leading edge.

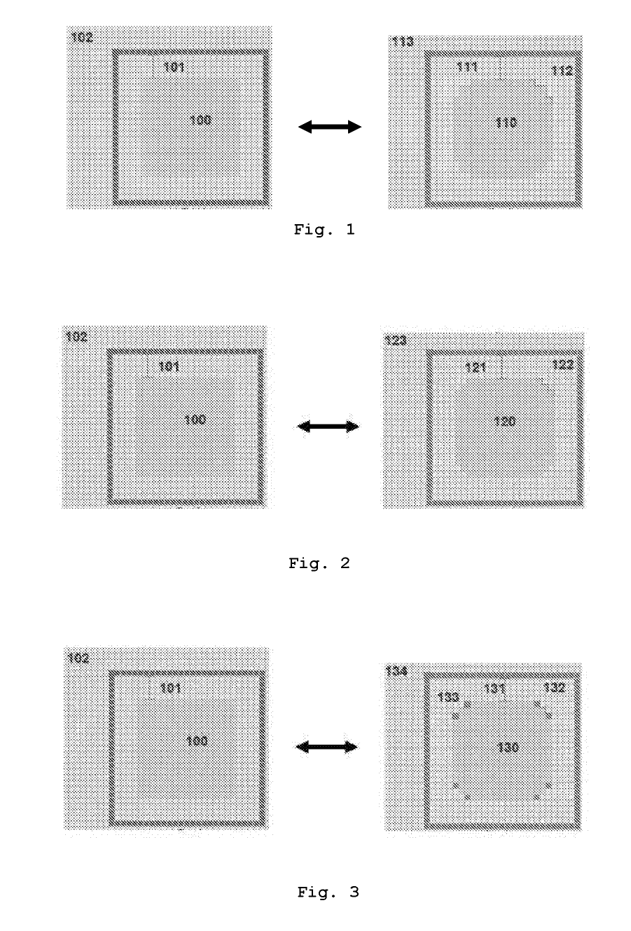

FIG. 2 illustrates one embodiment of a transition between an unselected option image and a selected option image, where the reference numbers show:
100—a superimposed inner square;
101—distance to the leading edge;
102—a leading edge;
120—a superimposed inner shape;
121—background;
122—an empty rounded corner with a 2 pixel radius;
123—leading border.

FIG. 3 illustrates one embodiment of a transition between an unselected option image and a selected option image, where the reference numbers show:
100—a superimposed inner square;
101—distance to the leading edge;
102—a leading edge;
130—a superimposed inner shape;
131—background;
132—an empty rounded corner with a 2 pixel radius;
133—two outer pixel vertices of a corner with a brightness of 59%;
134—leading border.

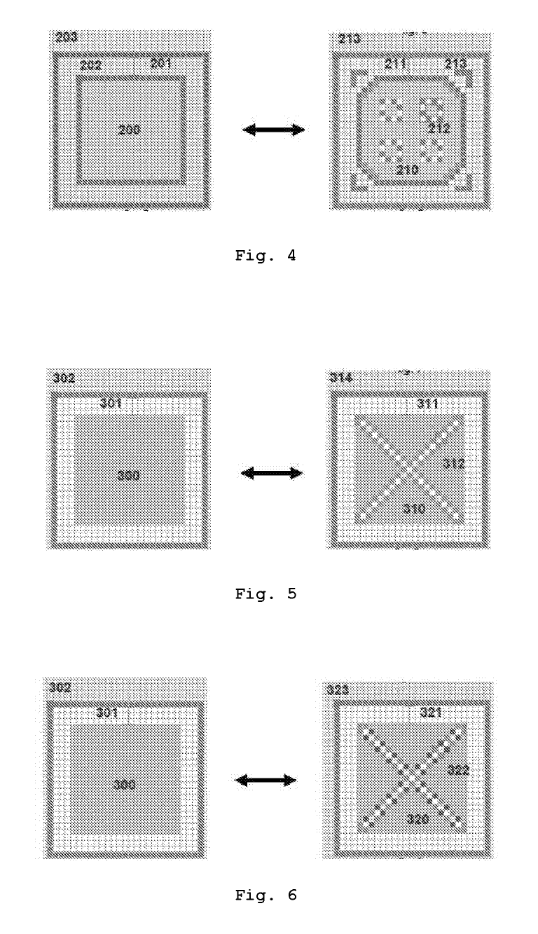

FIG. 4 illustrates one embodiment of a transition between an unselected option image and a selected option image, where the reference numbers show:
200—a superimposed inner square;
201—distance to the leading edge;
202—an inner edge;
203—leading edge;
210—a superimposed inner shape;
211—distance to the leading edge;
212—a small square inside inner square; and
213—leading edge.

FIG. 5 illustrates one embodiment of a transition between an unselected option image and a selected option image, where the reference numbers show:
300—a superimposed inner square;
301—distance to the leading edge;
302—leading edge;
310—a superimposed inner shape;
311—distance to the leading edge;
312—a superimposed inner cross;
314—leading edge.

FIG. 6 illustrates one embodiment of a transition between an unselected option image and a selected option image, where the reference numbers show:
300—a superimposed inner square;
301—distance to the leading edge;
302—leading edge;
320—a superimposed inner shape;
321—distance to the leading edge;
322—a superimposed inner cross;
323—leading edge.

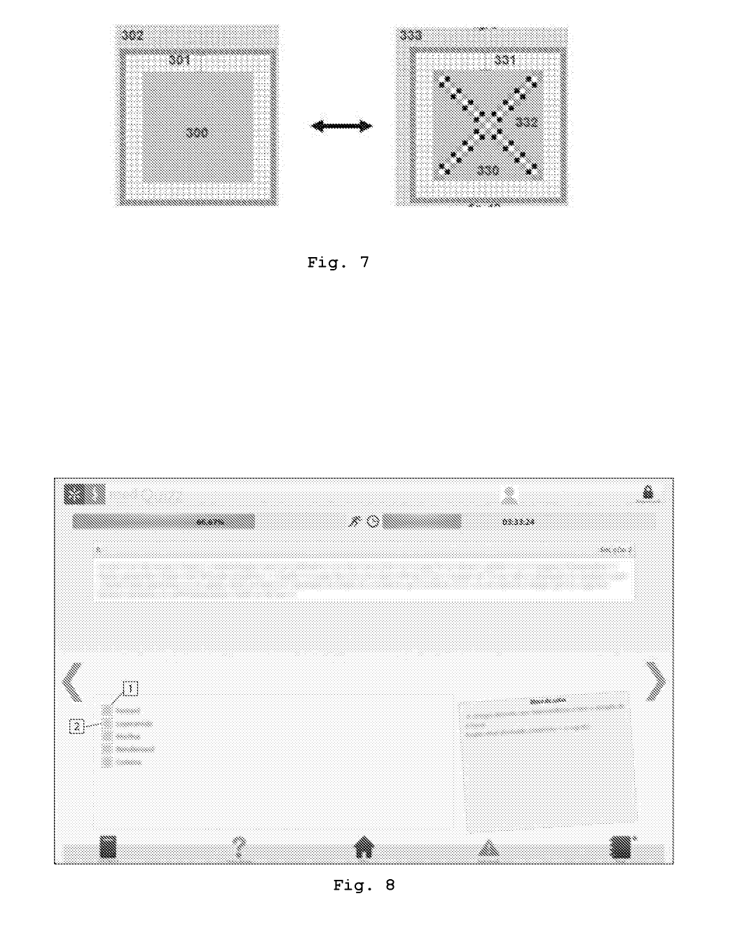

FIG. 7 illustrates one embodiment of a transition between an unselected option image and a selected option image, where the reference numbers show:
300—a superimposed inner square;
301—distance to the leading edge;
302—leading edge;
330—a superimposed inner shape;
331—distance to the leading edge;
332—a superimposed inner cross;
333—leading edge.

FIG. 8 illustrates one embodiment of an online medical quiz, where the reference numbers show:
1—unselected option image;
2—selected option image.

### DESCRIPTION OF EMBODIMENTS

Referring to the drawings, herein are described optional embodiments in more detail, which however are not intended to limit the scope of the present application.

The use of the present application relates to the construction of electronic interfaces for test administration, in particular, those composed of multiple choice questions or any other variant that is contingent on a choice, e.g. true/false; extended matching questions, correspondence, etc. Moreover, the method is particularly applicable in situations of filling out forms (e.g. examinations, tests, psychological tests, questionnaires, etc.), open and unopened voting systems, authentication systems (e.g. ATM, electronic gates, etc.), games and leisure (in electronic or physical formats; e.g. the tic-tac-toe can be played both in electronic and physical media).

Overall the present application may be appealing to various institutions that produce platforms for large-scale exams/surveys (e.g. Microsoft Blackboard, Universities, National Board of Medical Examiners, etc.), entities that specialize in evaluation, certification and selection of candidates (e.g. Pearson Vue, Department of Motor Vehicles), banks, institutions with voting systems (Parliament, the National Electoral Commission, associations, etc.).

An example of a physical medium in which the present technology could be used is exemplified by games composed of wooden pieces (cubes or trapezoids) that spin around a central axis. Each side could have one of the visual configurations. User then spins the piece to signal the choice. This would be visible to the direct user but not to a nearby person.

The embodiments presented in FIGS. 1 to 7 follow three models:
in model A one option tends to be a rounded square and the other tends to be a square;
in model B a simple square with a thin border is used for the unchecked option and a square with artifacts inside to represent the checked option;
model C combines the knowledge acquired in the model A and presents a cross inside the square, therefore increasing discrimination of the selected option for the visual impaired.

### Model A

FIGS. 1 to 3 illustrates embodiments of a transition between an unselected option image on the left and for a selected option image on the right.

The unselected option image comprises a 27 pixels side square and brightness 89% surrounded by a 1 pixel edge and brightness 48% (102). Inside there is another square 4 pixel distant from the leading edge (101) and has brightness 83% (100).

The selected option image on the right side of FIG. 1 illustrates a 27 pixel side square surrounded by a 1 pixel thick border, brightness 56% (113) and background with brightness 92% (111) has inside a square with brightness 83% and rounded corners 4 pixel in radius (112) but adding 1 pixel in the central vertex (110). This square is distant 4 pixel from leading edge (111).

The selected option image on the right side of FIG. 2 illustrates a 27 pixel side square surrounded by a 1 pixel thick border, brightness 56% (123) and background with brightness 92% (121) has inside a square with brightness 83% and rounded corners 2 pixel in radius (122). This square is distant 4 pixel the leading edge (121).

The selected option image on the right side of FIG. 3 illustrates a 27 pixel side square surrounded by a 1 pixel thick border, brightness 56% (134) and background with brightness 92% (131) has inside a square with brightness 83% and rounded corners 2 pixel in radius (132). The two vertices of each outer corner are filled with brightness 59% (133). This square is distant 4 pixel the leading edge (130).

### Model B

The unselected state in FIG. 4 comprises a 27 pixel side square and brightness 89% surrounded by a 1 pixel edge and brightness 48% (203). Inside there is another square 3 pixel distant from the leading edge (201), brightness 83% (200) and with 1 pixel edge brightness 53% (202).

The selected state on the right side of FIG. 4 illustrates a 27 pixel side square surrounded by a 1 pixel thick border, brightness 56% (213) and background with brightness 92% has four vertices consisting of 5 pixels (brightness 56%); these vertices are 2 pixel distant from the leading edge (213). Inside has a square with rounded corners with a 1 pixel edge, brightness 53% (210) and background 83%; this box is 3 pixel distant from the leading edge (211). The corners have a 3 pixel radius. The inner sides of the corners are filled with a 1 pixel diagonally line with 66% brightness. Finally inside the inner square there are four small squares, 4 pixel side, in which only the border is filled (212). The 1 pixel border is interspersed with 57 and 94 brightness points (212).

### Model C

The unselected state in the left side of FIGS. 5 to 7 comprises a 27 pixel side square and brightness 100% surrounded by 1 pixel edge and brightness 56% (302). Inside there is another square 3 pixel distant from the leading edge (301) and has brightness 77% (300).

The selected state on the right side of FIG. 5 illustrates a 27 pixel side square surrounded by a 1 pixel thick border, brightness 56% (314) and background with brightness 100% (310), has a cross composed of four 1 pixel thick lines each and brightness 64% and an inner interleaved line consisting of alternate pixels brightness 100% and 90% (312). The background of the square is distant 3 pixel from the edge and has brightness 77% (311).

The selected state on the right side of FIG. 6 illustrates a 27 pixel side square surrounded by a 1 pixel thick border, brightness 56% (323) and background with brightness 100% (321), has a cross composed of four 1 pixel thick lines each consisting of an outer interleaved line with intercalated pixels of brightness 64% and 41% and an inner interleaved line with intercalated pixels of brightness 100% and 90% (322). The bottom of the square is distant 3 pixel from the edge and has brightness 77% (320).

The selected state on the right side of FIG. 7 illustrates a 27 pixel side square surrounded by a 1 pixel thick border, brightness 56% (333) and background with brightness 100% (331), has a cross composed of four 1 pixel thick lines each consisting of an outer interleaved line with intercalated pixels of brightness 64% and 0% and an inner interleaved line with intercalated pixels of brightness 100% and 90% (332). The background of the square is distant 3 pixel from the edge and has brightness 77% (330).

### Experimental Results

Table 1 shows a set of experimental results obtained for these three models using a first screen display. The experiment comprised placing a user at a distance of 350 cm to a screen display and measuring the distance at which he/she starts seeing the difference between unselected and selected option images when performing a forward movement. Five men and five women performed the experiment.

TABLE 1
Experimental threshold distances for display 1

| FIG. | 1 | 2 | 3 | 4 | 5 | 6 | 7 |
|---|---|---|---|---|---|---|---|
| Median | 113 | 109.5 | 98.5 | 144.5 | 96.5 | 169 | 193 |
| Average | 131 | 108 | 121 | 150 | 100 | 175 | 207 |
| StdDev | 52.7 | 30.2 | 54.7 | 52.8 | 20.6 | 45.9 | 79.3 |
| SEM | 16.7 | 9.6 | 17.3 | 16.7 | 6.5 | 14.5 | 25.1 |
| Subj. 1 | 97 | 109 | 95 | 225 | 70 | 173 | 230 |
| Subj. 2 | 88 | 97 | 153 | 99 | 84 | 122 | 124 |
| Subj. 3 | 110 | 74 | 78 | 92 | 75 | 118 | 150 |
| Subj. 4 | 109 | 110 | 110 | 157 | 120 | 158 | 204 |
| Subj. 5 | 100 | 74 | 92 | 154 | 120 | 172 | 113 |
| Subj. 6 | 266 | 80 | 265 | 135 | 94 | 253 | 352 |
| Subj. 7 | 116 | 124 | 97 | 113 | 116 | 166 | 182 |
| Subj. 8 | 170 | 174 | 96 | 155 | 90 | 226 | 265 |
| Subj. 9 | 118 | 127 | 120 | 254 | 129 | 223 | 300 |
| Subj. 10 | 134 | 112 | 100 | 118 | 99 | 136 | 149 |

The first row of table 1 shows a relation to the corresponding figure of the present application. The following top rows show statistical indicators about the collected samples. The Standard Error of the Mean (SEM) indicator uses the following expression:

$$SEM ( S ) = \frac{{σ}_{S}}{\sqrt{N}}$$

where σ_{S} is the standard deviation of the sample set, and N is the length of said set.

Subjects 1, 3, 4, 8 and 10 are women, and the remaining are men.

Table 2 shows a replicated experiment where a different screen display was used with a higher pixel resolution.

TABLE 2
Experimental threshold distances for display 2

| FIG. | 1 | 2 | 3 | 4 | 5 | 6 | 7 |
|---|---|---|---|---|---|---|---|
| Median | 177.5 | 118.5 | 113.5 | 204.5 | 133 | 239 | 319 |
| Average | 182 | 139 | 121 | 205 | 144 | 219 | 306 |
| StdDev | 32.7 | 52.6 | 37.0 | 64.6 | 57.0 | 41.5 | 45.1 |
| SEM | 10.4 | 16.6 | 11.7 | 20.4 | 18.0 | 13.1 | 14.3 |
| Subj. 1 | 169 | 120 | 113 | 293 | 115 | 258 | 318 |
| Subj. 2 | 202 | 113 | 157 | 227 | 243 | 154 | 204 |
| Subj. 3 | 159 | 115 | 138 | 136 | 103 | 163 | 253 |
| Subj. 4 | 158 | 192 | 134 | 266 | 141 | 253 | 320 |
| Subj. 5 | 153 | 117 | 190 | 182 | 125 | 234 | 344 |
| Subj. 6 | 242 | 65 | 58 | 146 | 241 | 255 | 350 |
| Subj. 7 | 186 | 124 | 82 | 181 | 160 | 192 | 325 |
| Subj. 8 | 202 | 219 | 111 | 230 | 101 | 244 | 310 |
| Subj. 9 | 215 | 220 | 114 | 284 | 142 | 254 | 299 |
| Subj. 10 | 137 | 102 | 110 | 108 | 73 | 182 | 337 |

FIG. 8 illustrates an embodiment of an online medical quiz showing the available options in the lower left area. The selected option image (2) is visible to the user in front of it, but invisible to others since it is indistinguishable from the unselected option images (1).

Naturally, the present solution is not in any way limited to the embodiments described in this document and a person with average knowledge in the field will be able to predict many possible changes to it without deviating from the main idea, as described in the claims.

1. A method of operating a computing device, comprising the steps:
detecting a user selection event from an input interface;
display at least one unselected option image, comprising:
a background square where all pixels have a brightness of at least 80%,
a superimposed inner square where all pixels have a brightness of at most 85%;
display at least one selected option image, comprising:
a background square where all pixels have a brightness of at least the unselected option image background square pixel brightness, and
a superimposed inner shape comprising at least 1 pixel of the unselected option image inner square.

2. Method according to claim 1, wherein the inner shape, is the superimposed inner square with empty rounded corners with at least one pixel radius.

3. Method according to claim 2, wherein the empty rounded corner has a 4 pixel radius and a 1 pixel central vertex.

4. Method according to claim 1, wherein the inner shape comprises at least 1 pixel with at most the unselected option image inner square pixel brightness.

5. Method according to claim 4, wherein the two outer pixel vertices of each corner have a brightness of 59%.

6. Method according to claim 1, wherein the selected option image comprises a superimposed inner cross with a brightness of at most the inner shape pixel brightness, and an inner line with alternate pixel brightness between 100% and 90%.

7. Method according to claim 6, wherein the inner cross has an outer line with alternate pixel brightness between 64% and 41%.

8. Method according to claim 6, wherein the inner cross has an outer line with alternate pixel brightness between 64% and 0%.

9. Method according to claim 1, wherein the selected option image comprises an edge with a width of at least 1 pixel and a brightness of at most the unselected option image background square pixel brightness.

10. Method according to claim 1, wherein the brightness of a pixel is the normalized arithmetic mean of its red-green-blue coordinates.

11. Method according to claim 1, wherein the brightness of a pixel is the value of its grayscale coordinate.

12. A computing device, comprising:
a screen display;
at least one input interface;
a data processing means; and
a memory,
where the system is configured to implement the method described in claim 1.

13. System according to claim 12, wherein the input interface is any of:
a button;
a computer mouse;
a touch screen;
a camera; or
an infrared sensor.

14. A computer network, comprising at least one computing device as described in claim 12.
